(19) United States
(12) Patent Application Publication
(10) Pub. No.: US 2024/0118483 A1
(43) Pub. Date: Apr. 11, 2024

(54) Lightweight And Efficient Edge-Lit Luminaire

(71) Applicant: KENALL MANUFACTURING COMPANY, Kenosha, WI (US)

(72) Inventors: Kevin Dahlen, Lindenhurst, IL (US); Brandon Stolte, Lindenhurst, IL (US)

(21) Appl. No.: 17/961,491

(22) Filed: Oct. 6, 2022

(51) Int. Cl. F21V 8/00; F21K 9/61

(52) U.S. Cl. CPC G02B 6/0073; F21K 9/61; G02B 6/0055; F21Y 2115/10

(57) ABSTRACT

A lightweight and efficient edge-lit luminaire adapted to be installed in an environment. The edge-lit luminaire includes a housing, a light source disposed adjacent a perimeter edge of the housing, and an optical element having one or more perimeter edges disposed immediately adjacent the light source. The optical element includes a plurality of walls configured to direct light emitted by the light source out of the housing and into the environment.

### FIELD

The present disclosure generally relates to luminaires and, more particularly, to an edge-lit luminaire that is lightweight and efficient.

### BACKGROUND

Commercial buildings, parking structures, transportation areas or structures, and other similar environments are equipped with lighting systems that typically include several luminaires or light fixtures configured to illuminate certain areas of those environments. These luminaires can be back-lit luminaires, whereby the light source providing the illumination is arranged in or at the base of the luminaire, or can be edge-lit luminaires, whereby the light source providing the illumination is arranged at the edge(s) of the luminaire. In some cases, back-lit luminaires are preferred, as back-lit luminaires tend to be less costly and more efficient (i.e., back-lit luminaires have a higher light output than edge-lit luminaires for the same power consumption). In other cases, however, edge-lit luminaires are preferred, as edge-lit luminaires tend to be shallower, easier to install, and more aesthetically pleasing within the environment. One example of an edge-lit luminaire that can be used is the TopTier LED product manufactured by Cooper Lighting Solutions.

### SUMMARY

One aspect of the present disclosure provides a lightweight and efficient edge-lit luminaire adapted to be installed in an environment. The edge-lit luminaire includes a housing, a light source disposed adjacent a perimeter edge of the housing, and an optical element having one or more perimeter edges disposed immediately adjacent the light source. The optical element includes a plurality of walls configured to direct light emitted by the light source out of the housing and into the environment.

Another aspect of the present disclosure provides a lightweight and efficient edge-lit luminaire adapted to be installed in an environment. The edge-lit luminaire includes a housing, a light source disposed adjacent a perimeter edge of the housing, and an optical element having one or more perimeter edges disposed immediately adjacent the light source. The optical element is configured to direct light emitted by the light source out of the housing and into the environment. The edge-lit luminaire also includes a tray for the optical element. The tray includes a reflective surface positioned immediately adjacent the optical element and configured to reflect light toward the optical element.

Another aspect of the present disclosure provides a lightweight and efficient edge-lit luminaire adapted to be installed in an environment. The edge-lit luminaire includes a housing and a light source disposed adjacent a perimeter edge of the housing, the light source including a plurality of light-emitting diodes (LEDs). The edge-lit luminaire also includes an optical element configured to direct light emitted by the plurality of LEDs out of the housing and into the environment, and a tray for the optical element. The tray includes a reflective surface disposed immediately adjacent the optical element and configured to reflect light toward the optical element. The plurality of LEDs includes a first set of LEDs and a second set of LEDs, the first set of LEDs disposed on a first portion of the tray, and the second set of LEDs disposed on a second portion of the tray.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a front perspective view of one example of an edge-lit luminaire constructed in accordance with the teachings of the present disclosure;

FIG. 2 is a bottom perspective view of the edge-lit luminaire shown in FIG. 1;

FIG. 3 is similar to FIG. 2, but with the components of the edge-lit luminaire shown translucently for illustrative purposes;

FIG. 4 is a first cross-sectional view of the edge-lit luminaire of FIG. 1;

FIG. 5 is a second cross-sectional view of the edge-lit luminaire of FIG. 1;

FIG. 6 is a third cross-sectional view of the edge-lit luminaire of FIG. 1;

FIG. 7 is a perspective view of the light source employed in the edge-lit luminaire of FIG. 1;

FIG. 8 is a first exploded view of the edge-lit luminaire of FIG. 1;

FIG. 9 is a second exploded view of the edge-lit luminaire of FIG. 1;

FIG. 10 is a close-up view of the optical element employed in the edge-lit luminaire of FIG. 1;

FIG. 11 is a close-up of FIG. 10, and shows how the edge-lit luminaire of FIG. 1 provides a component of light in a highly efficient manner;

FIG. 12 is a plot of one example of light distribution from the edge-lit luminaire of FIG. 1 as a function of the vertical angle from the horizontal; and

FIG. 13 is a plot of light distribution from a known edge-lit luminaire.

### DETAILED DESCRIPTION

The present disclosure is directed to an edge-lit luminaire adapted to be installed in an environment. The edge-lit luminaire includes a light source that is arranged at the edge(s) of the luminaire but provides illumination to the environment surrounding the edge-lit luminaire in a highly efficient manner. The edge-lit luminaire is also small and lightweight, such that the edge-lit luminaire is easy to install and more aesthetically pleasing within the environment.

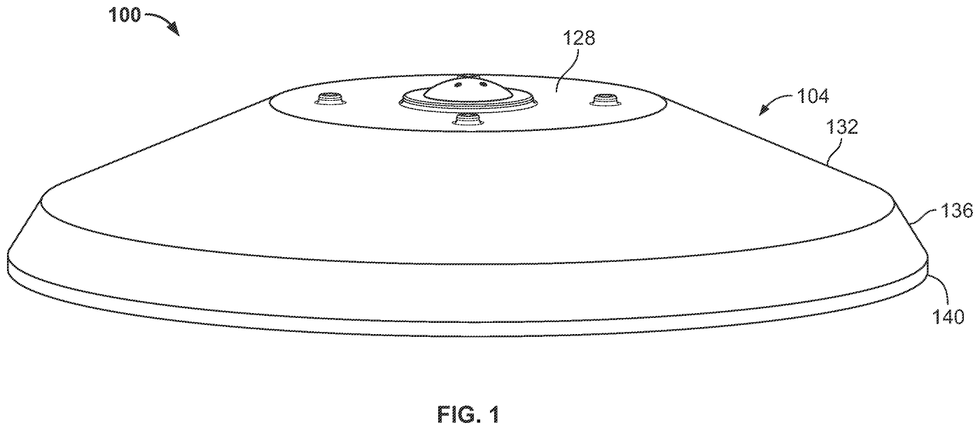

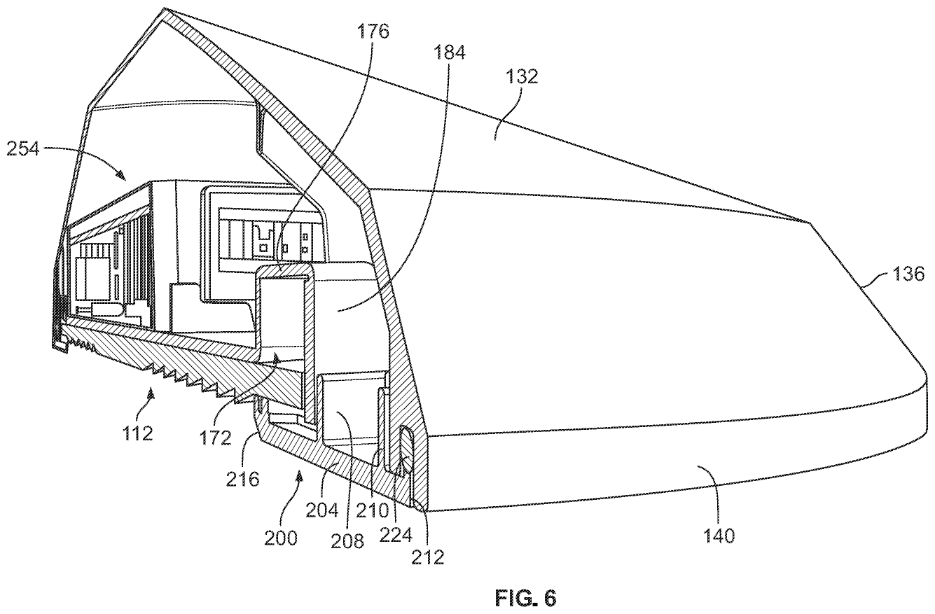

FIGS. 1-11 illustrate one example of an edge-lit luminaire 100 constructed in accordance with the present disclosure. The edge-lit luminaire 100 is generally adapted to be installed in a parking garage (or a floor or section of the parking garage), commercial building (or a portion thereof), roadway, tunnel, or other structure (or a portion thereof), residential home or building, or other indoor or outdoor space or environment. Thus, the edge-lit luminaire 100 is generally adapted to be mounted to a ceiling, wall, beam, or other structure or surface in the desired indoor or outdoor space or environment. For example, the edge-lit luminaire 100 can be mounted to a concrete beam in a parking garage.

The edge-lit luminaire 100 generally includes a housing 104, a light source 108 disposed within the housing 104, an optical element 112 carried by the housing 104 at a position adjacent the light source 108, and a tray 116 (which may also be referred to as a reflector) disposed in the housing 104. When the edge-lit luminaire 100 is operatively installed in the desired environment, the edge-lit luminaire 100 is configured to provide light as desired to an area (or all) of that environment. More particularly, the light source 108 is configured to emit light from the edge(s) of the housing 104, and the optical element 112 is configured to facilitate distribution of light emitted by the light source 108 to the area of the environment surrounding the edge-lit luminaire 100. In some cases, the tray 116 can be configured to help with the distribution of light by reflecting light toward the optical element 112.

The housing 104 is generally configured to be mounted to the ceiling, wall, beam, or other structure or surface in the environment in order to install the edge-lit luminaire 100. The housing 104 is preferably mounted to the desired structure or surface via a mounting bracket (not shown), but in some cases, the housing 104 can be directly mounted to the desired structure or surface. The housing 104 is preferably made of or from aluminum (e.g., aluminum 360), but may be made of one or more other suitable materials. As best illustrated in FIGS. 1-6, the housing 104 in this example has a generally circular shape that is defined by a mounting surface 128, a first wall 132 that extends radially outwardly from the mounting surface, a second wall 136 that extends radially outwardly from the first wall 132, and a perimeter edge 140. In the orientation illustrated in FIGS. 1-6, the mounting surface 128 is a flat surface that is disposed on the top of the housing 104, such that the first wall 132 extends both radially outwardly and downwardly from the mounting surface 128, the second wall 136 extends both radially outwardly and downwardly from the first wall 132, and the perimeter edge 140 extends downwardly from the second wall 136 and faces the environment in which the edge-lit luminaire 100 is installed. In turn, at least in this example, the first wall 132 is oriented at an angle of between 15 degrees and 60 degrees (e.g., 45 degrees) relative to the mounting surface 128, and the second wall 136 is oriented at an angle of between 30 degrees and 75 degrees (e.g., 60 degrees) relative to the first wall 132. In other examples, however, the housing 104 can instead have a different shape (e.g., a more rectangular or square shape). For example, the mounting surface 128 need not be a flat surface, the first wall 132 can be oriented differently relative to the mounting surface 128, and/or the second wall 136 can be oriented differently relative to the first wall 132.

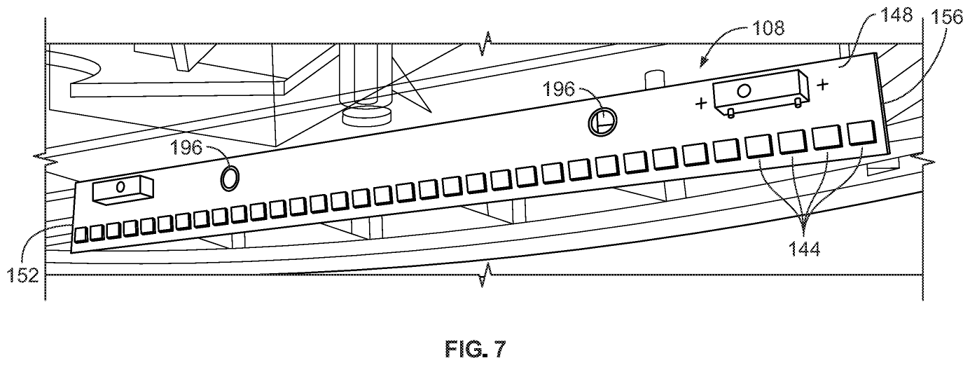

The light source 108 is generally configured to emit light for illuminating the area of the environment surrounding the edge-lit luminaire 100. In this example, the light source 108 takes the form of a plurality of light-emitting diodes (LEDs) 144 arranged on a plurality of printed circuit boards (PCBs) 148. More particularly, the light source 108 in this example takes the form of six sets of LEDs 144 (which together comprise the plurality of LEDs 144) arranged on six different PCBs 148, though in other examples, more or less sets of LEDs 144 and/or more or less PCBs 148 may be utilized. As best illustrated in FIG. 7, each PCB 148 has a thin, substantially rectangular, and elongate profile that extends between a first end 152 and a second end 156 opposite the first end 152. Each set of LEDs 144 is arranged on a respective PCB 148 such that the LEDs 144 are arranged between the first end 152 and the second end 156 of that PCB 148. In this example, each set of LEDs 144 includes thirty-four (34) LEDs 144, with each of the LEDs 144 disposed in parallel with one another and approximately evenly spaced apart from one another. In other examples, more or less LEDs 144 can be employed in each set, and/or the LEDs 144 can be arranged differently relative to one another and/or the PCB 148.

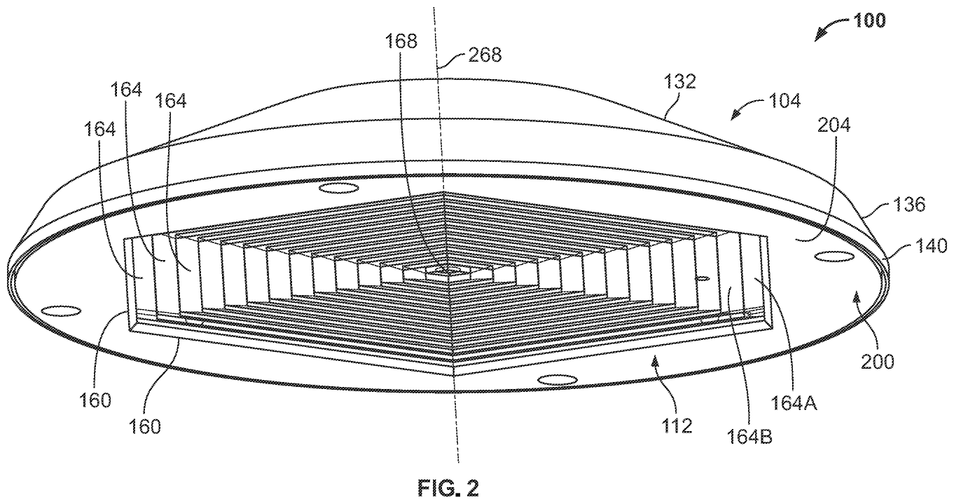

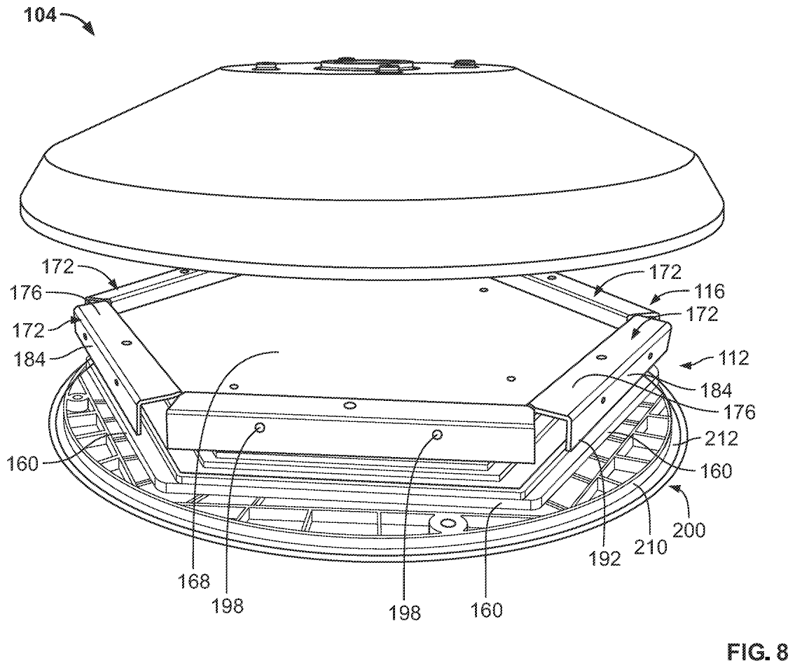

The optical element 112 is generally configured to facilitate distribution of light emitted by the light source 108 to the area of the environment surrounding the edge-lit luminaire 100. As best illustrated in FIGS. 2 and 8, the optical element 112 in this example takes the form of a lens made of or from a polycarbonate material (e.g., Makrolon) and having a hexagonal shape defined by six perimeter, flat edges 160. Importantly, as illustrated in FIGS. 2, 10, and 11, the lens includes a plurality of walls 164 that, as will be discussed in greater detail below, are configured to direct light emitted by the light source 108 out of the housing 104 and into the environment in a highly efficient manner. As also illustrated in FIG. 2, the plurality of walls 164 are generally concentrically arranged between the perimeter edges 160 and a central portion 168 of the optical element 112. In this example, because the lens has a hexagonal shape, each of the walls 164 has a hexagonal shape and surrounds the central portion 168. Thus, for example, the lens includes a first wall 164A that has a hexagonal shape and partially defines the perimeter edges 160, and a second wall 164 that also has a hexagonal shape and is disposed radially inwardly of the first wall 164. In other examples, however, the optical element 112 can have a different shape (e.g., a circular shape, a rectangular shape), in which case the plurality of walls 164 may have a different shape and/or may be arranged in a different manner.

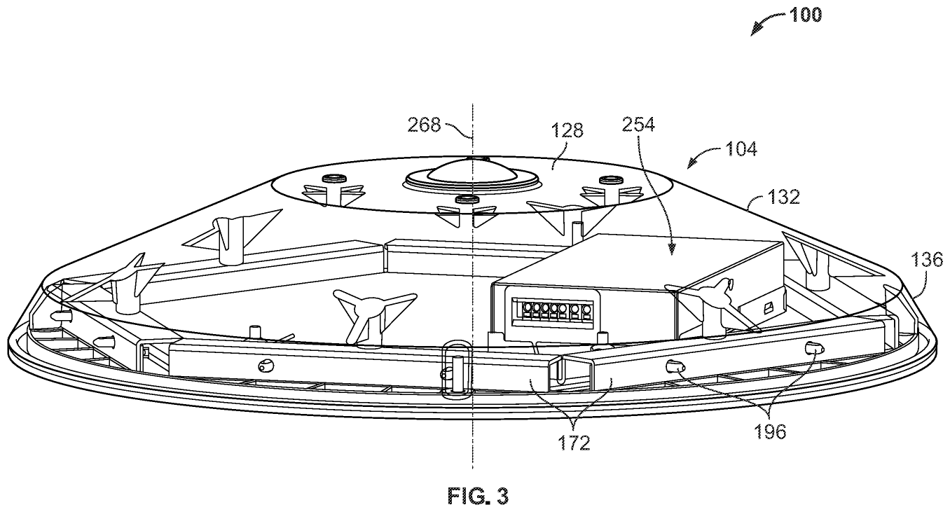

The tray 116 is a gear tray that is generally configured to maintain the optical element 112 within the housing 104 but also to support various electrical components within the housing 104. The tray 116 is preferably made of a reflective metallic material (e.g., aluminum) and has a shape that generally matches the shape of the optical element 112. Thus, in this example, the tray 116 also has a generally hexagonal shape. As best illustrated in FIGS. 3, 8, and 9, the tray 116 in this example has a hexagonal base surface 168 and a plurality of brackets 172 coupled to (e.g., integrally formed with) and extending outward from the base surface 168. The plurality of brackets 172 are generally configured to support the plurality of LEDs 144. Because in this example the edge-lit luminaire 100 includes six sets of LEDs 144 (and six different PCBs 148), the tray 116 in this example includes six brackets 172 arranged circumferentially around the base surface 168, with each bracket 172 configured to support one PCB 148 (and, in turn, one set of LEDs 144).

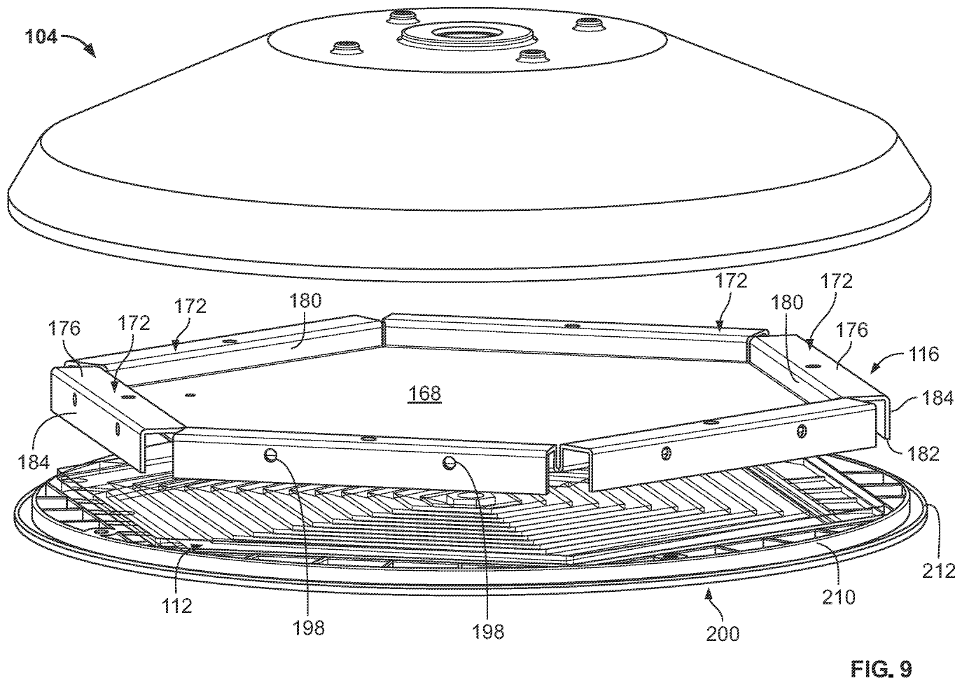

Each of the brackets 172 is identical in shape and size. As best illustrated in FIGS. 3, 8, and 9, each of the brackets 172 is an elongate, U-shaped bracket that is defined by a base 176, a first arm 180 coupled to (e.g., integrally formed with) a first portion of the base 176, and a second arm 184 coupled to (e.g., integrally formed with) a second portion of the base 176 that is radially outward of the first portion of the base 176. The first arm 180 of each bracket 172 is coupled to a perimeter edge of the base surface 168 and extends upward (at least in the orientation shown in FIGS. 1-6, 8, and 9). The base 176 of each bracket 172 then extends radially outwardly from the respective first arm 180 and terminates at the respective second arm 184. In turn, the second arm 184 of each bracket 172 extends downward (at least in the orientation shown in FIGS. 1-6, 8, and 9) from the respective base 176 and terminates at a respective free edge 192 (see FIGS. 8 and 9) at a position below (at least in the orientation shown in FIGS. 1-6, 8, and 9) the perimeter edge of the base surface 168. Thus, in this example, the first and second arms 180, 184 of each bracket 172 are co-axial with one another. In other examples, however, the brackets 172 can have a different shape and/or size. For example, the first and second arms 180, 184 of each bracket 172 can be oriented at an angle of approximately 45 degrees relative to the respective base 176.

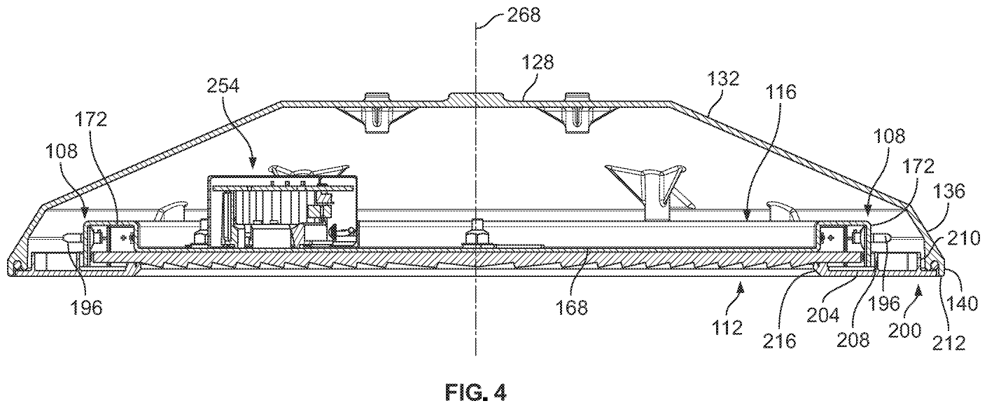

The light source 108 is generally coupled to the tray 116 so as to be positioned immediately adjacent the optical element 112. In this example, the PCBs 148 (and the sets of LEDs 144 respectively arranged thereon) are coupled to the plurality of brackets 172, respectively, of the tray 116. As best illustrated in FIGS. 4, 5, and 7, each PCB 148 is preferably coupled to the second arm 180 of a respective one of the brackets 172 such that the PCB 148, and the LEDs 144 arranged thereon, substantially span the entire length of the respective second arm 180 and face radially inward in different directions. In other examples, however, the PCBs 148 can be coupled to a different portion of the tray 116 and/or arranged differently relative to one another. Each PCB 148 is coupled to a respective one of the brackets 172 via one or more fasteners 196 (see FIGS. 4 and 7) extending through one or more apertures 198, respectively, formed in that bracket 172 (see FIGS. 8 and 9) and one or more apertures, respectively, formed in the PCB 148. While difficult to see in FIGS. 4 and 7, each of the fasteners 196 in this example takes the form of a drive fastener having a head and a body that is coupled to and extends outward from the head. Each head has a diameter that is larger than a diameter of the corresponding apertures 198 formed in the bracket 172 and the corresponding apertures formed in the PCB 148, while each body has a diameter that is less than the diameter of the corresponding apertures. This allows the fasteners 196 to be inserted through the apertures but yet securely retain the light source 108 in the desired position relative to the optical element 112. It will nonetheless be appreciated that the light source 108 can be coupled to the tray 116 in any number of different ways. As an example, the light source 108 can be coupled to the tray 116 using any other known fasteners. As another example, the light source 108 can be coupled to the tray 116 by welding or adhering the PCBs 148 to the tray 116.

The edge-lit luminaire 100 also includes a cover 200 that is coupled to the housing 104 (e.g., via a plurality of fasteners) in order to maintain the light source 108, the optical element 112, and the tray 116 in the housing 104. The cover 200 in this example is made of or from a polycarbonate material. The cover 200 in this example has a generally annular shape defined by a body 204, a first annular track 208 coupled to (e.g., integrally formed with) the body 204, and a second annular track 210 coupled to (e.g., integrally formed with) the body 204. The body 204 has an outer edge 212 and an inner edge 216 that is spaced radially inwardly of the outer edge 212 and defines an opening 220 through which the optical element 112 is visible. The first annular track 208 is coupled to the annular body 204 at a position between the outer edge 212 and the inner edge 216 (but closer to the inner edge 216). The second annular track 210 is coupled to the annular body 204 at a position between the outer edge 212 and the inner edge 216 (but closer to the outer edge 212). In this example, the outer edge 212 has an annular shape, and the inner edge 216 has a profile that generally matches the shape of the optical element 112. Thus, in this example, the inner edge 216 has a hexagonal profile, such that the opening 220 defined by the inner edge 216 is a hexagonal opening. In other examples, however, the inner edge 216 can instead have a circular or rectangular profile, such that the opening 220 is a circular or rectangular opening. In some examples, the edge-lit luminaire 100 also includes a first sealing element 224 (e.g., a sealing gasket made of rubber or silicone) that is disposed between a portion of the housing 104 and a portion of the cover 200 in order to effect a seal between the housing 104 and the cover 200. In this example, the first sealing element 224 has an annular shape and is disposed between the perimeter edge 140 and the outer edge 212. In other examples, however, the first sealing element 224 can have a different shape and/or can be disposed elsewhere to effect the seal between the housing 104 and the cover 200.

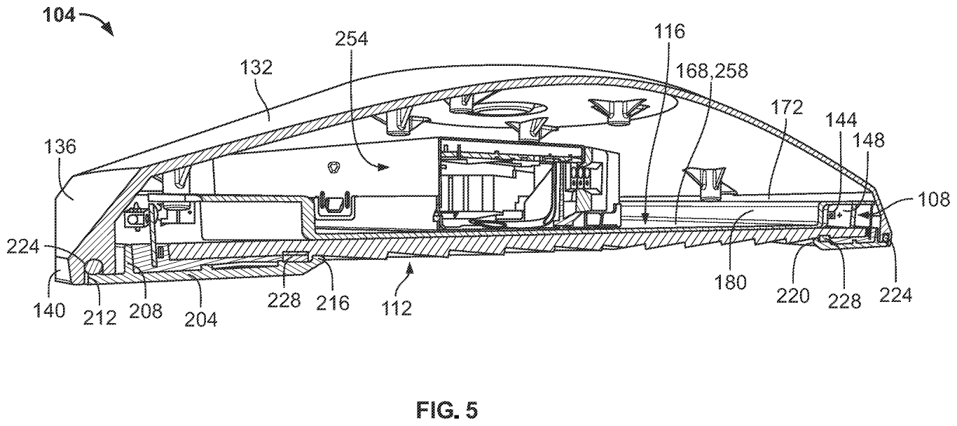

When the light source 108, the optical element 112, and the tray 116 (with the light source 108 coupled thereto) are disposed in the housing 104, and the cover 200 is coupled to the housing 104, the internal components of the edge-lit luminaire 100 are arranged in the manner illustrated in FIGS. 4-6. As illustrated, the optical element 112 is seated against an interior portion of the cover 200 (and, more particularly, the inner edge 216) such that the optical element 112 occupies the opening 220 of the cover 200. Thus, any light that is provided to the environment by the edge-lit luminaire 100 will necessarily first pass through the optical element 112. In some examples, the edge-lit luminaire 100 can also include a second sealing element 228 (e.g., a sealing gasket made of rubber or silicone) configured to effect a seal between the optical element 112 and the cover 220. In this example, the second sealing element 228 has a hexagonal profile (to match the shape of the optical element 112) and is disposed between the optical element 112 and an interior portion of the cover 220 in order to seal the interface between the optical element 112 and the cover 200, as illustrated in FIG. 5. In other examples, however, e.g., when the optical element 112 has a different shape, the second sealing element 228 will also have a different shape that matches the shape of the optical element 112.

Moreover, the tray 116 is disposed in the housing 104 such that (i) the base surface 168 is immediately adjacent and overlies (at least in the illustrated orientation) the optical element 112, (ii) the second arm 184 of each bracket 172 is seated against (or immediately adjacent to) the first annular track 208 of the cover 200, thereby securing the tray 116 in position, and (iii) the first arm 180 of each bracket 172 is disposed radially inwardly of the perimeter edges 160 of the optical element 112 but the second arm 184 of each bracket 172 is disposed radially outwardly of (but immediately adjacent to) the perimeter edges 160 of the optical element 112. In turn, the LEDs 144, which are carried by the second arm 184 of the brackets 172, are immediately adjacent the perimeter edges 160 of the optical element 112 and generally face toward the central portion 168 of the optical element 112.

The edge-lit luminaire 100 in this example also includes a driver 254 generally configured to electrically power the light source 108. In this example, the driver 254 takes the form of an LED driver configured to electrically power the light source 108, particularly the LEDs 144. In other examples, e.g., when the edge-lit luminaire 100 includes different light sources, the driver 254 can be a different type of driver. As illustrated in FIGS. 3-6, the driver 254 in this example is mounted to a top side 258 of the tray 116 via any known means (e.g., via a plurality of fasteners, via adhesive, etc.). As also illustrated, the driver 254 is offset from a central longitudinal axis 262 of the edge-lit luminaire 100, such that the driver 254 is also offset from the central portion 168 of the optical element 112 (which is generally aligned with the central longitudinal axis 262). In other examples, however, the driver 254 can be coupled to the tray 116 in a different manner and/or location or can be coupled to a different component of the edge-lit luminaire 100 (e.g., the housing 104 directly)

It will be appreciated that the edge-lit luminaire 100 includes additional components disposed in the housing 104. First, the edge-lit luminaire 100 includes wiring that connects the electronic components (e.g., the driver 254 and the PCBs 148) to one another. The edge-lit luminaire 100 may also, for example, include a local controller that communicates data (e.g., operational instructions, motion data) with a central controller or other edge-lit luminaires 100 (or other luminaires) in the environment, one or more communication modules (e.g., one or more antennae, one or more receivers, one or more transmitters) to effectuate wired or wireless communication between the edge-lit luminaire 100 and a central controller or other edge-lit luminaires 100 (or other luminaires), and one or more motion sensors for detecting motion in the environment. Further, the edge-lit luminaire 100 may include a heat sink or other means for dissipating heat generated by the LEDs 144 within the housing 104. Other components may be disposed in the housing 104 as well. As an example, the edge-lit luminaire 100 may include a nightlight and switch assembly that interfaces between the driver 254 and the PCBs 148 to adjust drive current supplied by the driver 254 to the LEDs 144. As another example, the edge-lit luminaire 100 may include a driver cover arranged to cover and protect the driver 254.

When the edge-lit luminaire 100 is in operation, the LEDs 144, which are positioned adjacent the perimeter edge 140 of the housing 104, emit light in a radially inward direction, toward the central longitudinal axis 262 of the edge-lit luminaire 100. Some of the light emitted by the LEDs 144 will be directed to the optical element 112, which is positioned immediately adjacent the LEDs 144. The rest of the light emitted by the LEDs 144 will be directed to the tray 116, which will in turn direct that light to the optical element 112. In particular, any light emitted by the LEDs 144 and directed to the base 176 or the first arm 180 of the brackets 172 will be directed downward, into the optical element 112.

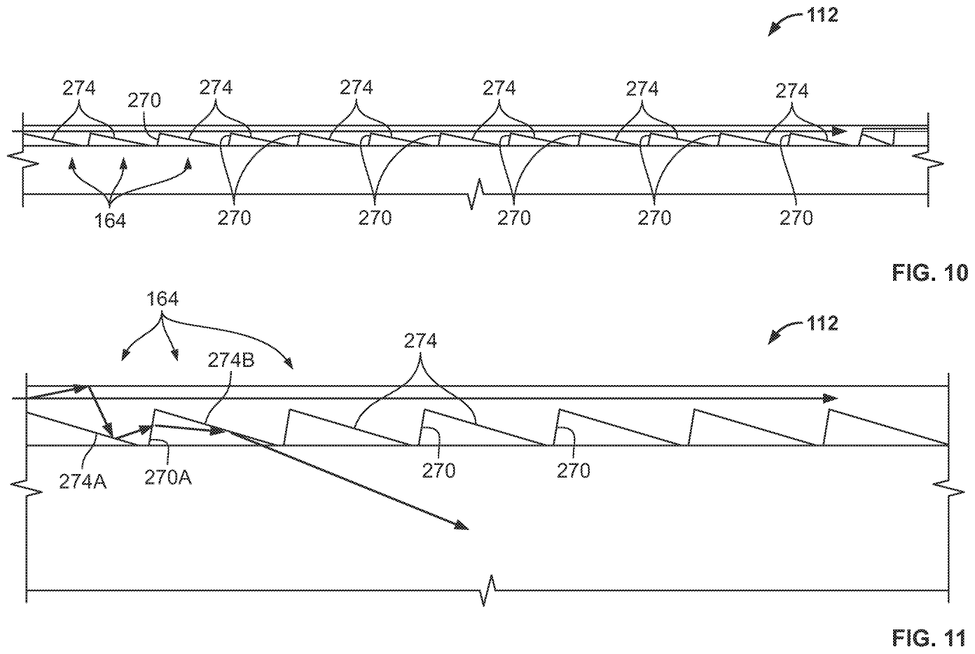

As the light emitted by the LEDs 144 travels to and through the optical element 112, that light is provided to the area of the environment surrounding the edge-lit luminaire 100. However, unlike known edge-lit luminaires (e.g., the TopTier LED product briefly mentioned above), the edge-lit luminaire 100 provides the light in a highly efficient manner. More particularly, the plurality of walls 164 of the optical element 112 are oriented so as to define light-emitting edges 270 and light-guiding edges 274 that cooperate to distribute components of the light to the environment at very high angles (relative to the central longitudinal axis 262). In this example, the light-emitting edges 270 are oriented at an angle of approximately 45 degrees relative to the central longitudinal axis 262, whereas the light-guiding edges 274 are substantially parallel to the central longitudinal axis 262, as illustrated in FIG. 10. Meanwhile, because the tray 116 is preferably (entirely or partially) made of a reflective metallic material, and because the base surface 168 of the tray 116 is immediately adjacent the optical element 112, any light directed toward the base surface 168 by the light-guiding edges 274 is in turn reflected back toward the optical element 112, whereby the light-emitting edges 270 and light-guiding edges 274 cooperate to distribute components of the reflected light to the environment at very high angles.

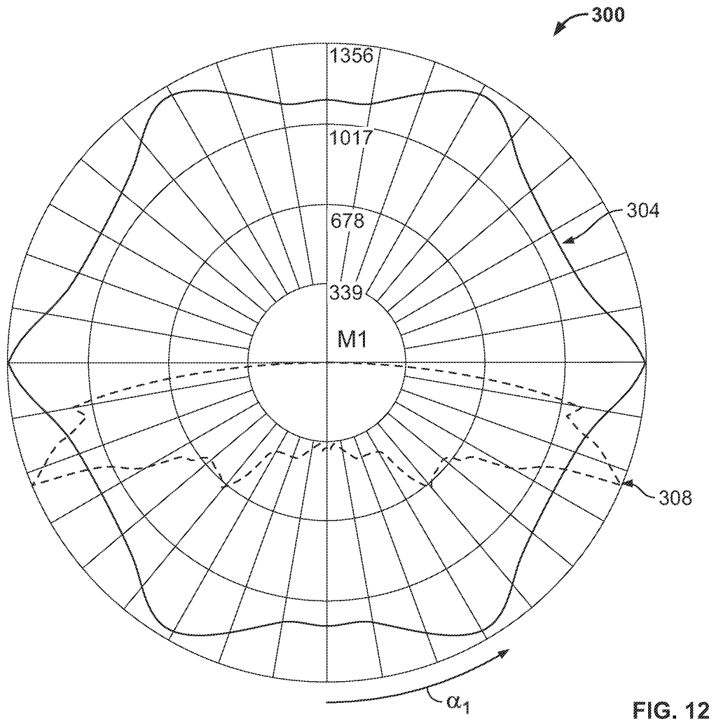

FIG. 11, for example, illustrates how the optical element 112 and the tray 116 can provide a component of the light emitted by the LEDs 144 to the area of the environment surrounding the edge-lit luminaire 100 in a highly efficient manner. As illustrated, the component of light reaches the optical element 112, hits the base surface 168 of the tray 116 (not specifically shown in FIG. 11, but disposed directly above the optical element 112), which reflects the component back toward the optical element 112. The reflected component then hits a first light-guiding edge 274A, which guides the component toward the light-emitting edge 270A adjacent thereto. The light-emitting edge 270A directs the component toward and into contact with a second light-guiding edge 274B adjacent thereto, and because of how the light-emitting edges 270 and the light-guiding edges 274 are oriented, the component strikes the second light-guiding edge 274 at an angle that directs the component out of the optical element 112 (and out of the edge-lit luminaire 100) at a very high angle (e.g., approximately 60-70 degrees). More generally, because of how the light-emitting edges 270 and the light-guiding edges 274 are oriented, approximately 15% of the light emitted by the LEDs 144 is directed out of the optical element 112 by the first light-emitting edge 270 that the light contacts, and the majority of the light emitted by the LEDs 144 emerges from one of the light-emitting edges 270.

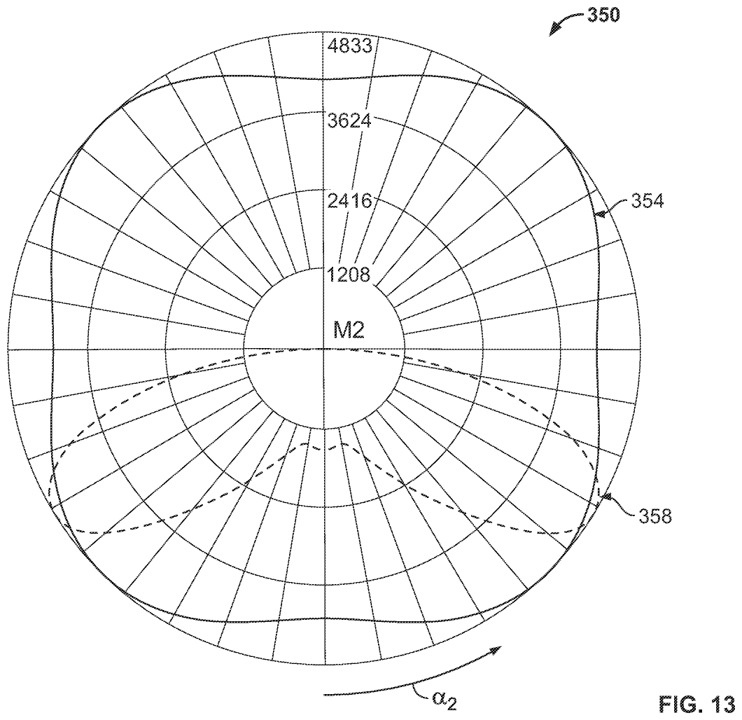

In turn, the edge-lit luminaire 100 distributes light to the area of the environment surrounding the edge-lit luminaire 100 in a manner that is less lambertian and is wider and more defined than known edge-lit luminaires such as the TopTier LED product briefly mentioned above. The distribution plot 300 illustrated in FIG. 12 is a two-dimensional polar graph that depicts the magnitude M1 of the intensity of the light output from the edge-lit luminaire 100 as a function of the vertical α₁ from the horizontal. As shown in FIG. 12, the distribution plot 300 includes (i) a first light distribution 304 measured along a plane that is orthogonal to the central longitudinal axis 262 and is beneath the edge-lit luminaire 100, and (ii) a second light distribution 308 measured along a plane that includes the central longitudinal axis 262 and extends through the optical element 112. Meanwhile, the light distribution plot 350 illustrated in FIG. 13 is a two-dimensional polar graph that depicts the magnitude M2 of the intensity of the light output from, for example, the TopTier LED product as a function of the vertical α₂ from the horizontal. As shown in FIG. 13, the distribution plot 350 includes (i) a first light distribution 354 measured along a plane that is orthogonal to the central longitudinal axis 262 and is beneath the edge-lit luminaire 100, and (ii) a second light distribution 358 measured along a plane that includes the central longitudinal axis 262 and extends through the optical element 112. By comparing the distribution plots 300 and 350, it will be appreciated that the first light distribution 304 produced by the edge-lit luminaire 100 is less lambertian than the first light distribution 354 produced by the TopTier LED product, and the second light distribution 308 produced by the edge-lit luminaire 100 is wider and more defined than the second light distribution 358 produced by the TopTier LED product.

At the same time, the edge-lit luminaire 100 is smaller and much more lightweight than known edge-lit luminaires. For example, the edge-lit luminaire 100 has a height H of approximately 2.75 inches, whereas the TopTier LED product has a height of approximately 5 inches. As another example, the edge-lit luminaire 100 weighs approximately 6 lbs, whereas the TopTier LED product weighs approximately 18 lbs.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1. An edge-lit luminaire adapted to be installed in an environment, the edge-lit luminaire comprising:
a housing comprising a mounting surface adapted to mount the edge-lit luminaire in the environment;
a light source disposed adjacent a perimeter edge of the housing; and
an optical element having a first side, a second side, and one or more perimeter edges disposed immediately adjacent the light source, the first side facing the mounting surface, and the second side of the optical element comprising a plurality of angled walls configured to direct light emitted by the light source out of the housing and into the environment.

2. The edge-lit luminaire of claim 1, wherein the one or more perimeter edges of the optical element comprise a plurality of flat perimeter edges.

3. The edge-lit luminaire of claim 1, wherein the optical element comprises a lens having a hexagonal shape.

4. (canceled)

5. The edge-lit luminaire of claim 1, further comprising a reflective surface positioned immediately adjacent the optical element and configured to reflect light toward the optical element.

6. The edge-lit luminaire of claim 1, further comprising a cover coupled to the housing, the optical element seated against the cover.

7. The edge-lit luminaire of claim 6, further comprising a sealing element disposed between the optical element and the cover.

8. An edge-lit luminaire adapted to be installed in an environment, the edge-lit luminaire comprising:
a housing;
a light source disposed adjacent a perimeter edge of the housing;
an optical element having one or more perimeter edges disposed immediately adjacent the light source, the optical element configured to direct light emitted by the light source out of the housing and into the environment; and
a tray for the optical element, the tray comprising a base composed of a reflective surface positioned above the optical element and configured to reflect light toward the optical element.

9. The edge-lit luminaire of claim 8, wherein the one or more perimeter edges comprise a plurality of flat perimeter edges.

10. The edge-lit luminaire of claim 8, wherein the optical element comprises a lens having a hexagonal shape.

11. The edge-lit luminaire of claim 8, wherein the light source comprises a plurality of light-emitting diodes coupled to the tray.

12. The edge-lit luminaire of claim 8, further comprising a cover coupled to the housing, the optical element seated against the cover.

13. The edge-lit luminaire of claim 8, wherein the optical element comprises a plurality of walls configured to direct light emitted by the light source out of the housing and into the environment.

14. The edge-lit luminaire of claim 8, wherein the optical element is fully recessed relative to a lower perimeter edge of the housing.

15. An edge-lit luminaire adapted to be installed in an environment, the edge-lit luminaire comprising:
a housing;
a light source disposed adjacent a perimeter edge of the housing, the light source comprising a plurality of light-emitting diodes (LEDs);
an optical element configured to direct light emitted by the plurality of LEDs out of the housing and into the environment; and
a tray for the optical element, the tray having a hexagonal shape and comprising a reflective surface disposed immediately adjacent the optical element and configured to reflect light toward the optical element,
wherein the plurality of LEDs comprises a first set of LEDs and a second set of LEDs, the first set of LEDs disposed on a first portion of the tray, and the second set of LEDs disposed on a second portion of the tray.

16. The edge-lit luminaire of claim 15, wherein the optical element has one or more perimeter edges disposed immediately adjacent one or more of the plurality of LEDs.

17. The edge-lit luminaire of claim 15, wherein the optical element comprises a plurality of walls configured to direct light emitted by the light source out of the housing and into the environment.

18. The edge-lit luminaire of claim 15, wherein the optical element comprises a lens having a hexagonal shape.

19. The edge-lit luminaire of claim 15, further comprising a cover coupled to the housing, the optical element seated against the cover.

20. The edge-lit luminaire of claim 15, wherein the optical element is recessed relative to the perimeter edge of the housing.

21. The edge-lit luminaire of claim 15, wherein the tray comprises a base composed of the reflective surface, the reflective surface disposed above the optical element.

22. The edge-lit luminaire of claim 1, wherein the optical element is fully recessed relative to the housing.
